(19) United States
(12) Patent Application Publication
(10) Pub. No.: US 2017/0132020 A1
(43) Pub. Date: May 11, 2017

(54) CODE PROCESSING METHOD AND CODE PROCESSING DEVICE

(71) Applicants: LE HOLDINGS (BEIJING) CO., LTD., Beijing (CN); Lemobile Information Technology (Beijing) Co., Ltd, Beijing (CN)

(72) Inventors: Xianshan WANG, Beijing (CN); Yan YU, Beijing (CN)

(21) Appl. No.: 15/232,715

(22) Filed: Aug. 9, 2016

Related U.S. Application Data
(63) Continuation of application No. PCT/CN2016/089109, filed on Jul. 7, 2016.

(30) Foreign Application Priority Data
Nov. 6, 2015 (CN) 201510756759.7

(51) Int. Cl. G06F 9/445

(52) U.S. Cl. CPC G06F 9/44505; G06F 9/44589

(57) ABSTRACT

An embodiment of the present disclosure discloses a code processing method and a code processing device. The method is characterized by comprising: acquiring saved information of characteristic parameters of hardware configurations: loading the characteristic parameters of the hardware configurations into basic codes according to the saved information, wherein the basic codes are shared by the mobile terminals with different hardware configurations. According to the embodiment of the present disclosure, development and maintenance workload of software codes in the mobile terminals is reduced.

### CROSS-REFERENCE TO RELATED APPLICATIONS

The present disclosure is a continuation of International Application PCT/CN2016/089109 filed on Jul. 7, 2016, which is based upon and claims priority to Chinese Patent Application No. 201510756759.7, entitled “CODE PROCESSING METHOD AND CODE PROCESSING DEVICE”, filed to State Intellectual Property Office of The P.R.C on Nov. 6, 2015, the entire contents of all of which are incorporated herein by reference.

### TECHNICAL FIELD

The present disclosure generally relates to the field of communication technology, in particular to a code processing method and a code processing device.

### BACKGROUND

With the rapid development of information technology, mobile terminals have become more popular in people's lives, and hardware configurations are used to represent basic hardware configurations of load-balanced mobile terminals, for example: LCDs (Liquid Crystal Display), memories, hard disks, etc. Because the hardware configurations of the mobile terminals are adjusted correspondingly according to the requirements of different users, mobile terminals with different hardware configurations are produced.

Because the hardware configurations of the mobile terminals are controlled by software codes, the hardware configurations can play roles via support of the software codes, namely the hardware configurations in the mobile terminals need to be supported with a set of corresponding codes, so that the hardware configurations can play their roles.

However, when the hardware configurations of the mobile terminals are different, a plurality of sets of different software codes need to be developed according to different hardware configurations, and saved in the mobile terminals, so that the mobile terminals can determine which set of software codes to use via a compiler toggle when starting. This way, the development workload of the software codes is great. When the software codes are maintained, a plurality of sets of software codes will result in great workload.

### SUMMARY

An embodiment of the present disclosure discloses a code processing method and a processing device. The method and the device are applicable to overcome the shortcoming of a great development and maintenance workload of the software codes caused by developing a plurality sets of software codes according to different hardware configurations in prior art, and to reduce the development and maintenance workload of the software codes in mobile terminals.

According to an aspect of the present disclosure, the embodiment of the present disclosure provides a code processing method, including:
acquiring saved information of characteristic parameters of hardware configurations;
loading the characteristic parameters of the hardware configurations into basic codes according to the saved information, wherein the basic codes are shared by the mobile terminals with different hardware configurations.

According to another aspect of the present disclosure, the embodiment of the present disclosure further provides a mobile terminal for code processing, including: at least one processor; and a memory communicably connected with the at least one processor for storing instructions executable by the at least one processor, wherein execution of the instructions by the at least one processor causes the at least one processor to:
acquire saved information of characteristic parameters of hardware configurations;
load the characteristic parameters of the hardware configurations into basic codes according to the saved information, wherein the basic codes are shared by the mobile terminals with different hardware configurations.

According to still another aspect of the present disclosure, the present disclosure provides a computer program, including computer readable codes; when the computer readable codes are run on the mobile terminals, the mobile terminals carry out the code processing method.

According to yet another aspect of the present disclosure, the present disclosure provides a computer readable medium to which the computer program is saved.

The present disclosure has the following advantages:
according to the code processing method and the code processing device disclosed in the embodiment of the present disclosure, the relevant characteristic parameters of the hardware configurations are loaded into the basic codes, so that the basic codes become a set of integral software codes capable of supporting the hardware configurations of the mobile terminals; this is because the mobile terminals with different hardware configurations share the basic codes, namely a plurality of hardware configurations can share the basic codes; therefore, compared with a set of software codes corresponding to various mobile terminals with different hardware configurations in prior art, the relevant characteristic parameters of the hardware configurations and the basic codes shared by various hardware devices can be treated as a set of software codes, namely a set of software codes are developed and saved in the mobile terminals; therefore, the development and maintenance workload of the software codes in the mobile terminals is reduced.

Description above is an overview of the technical scheme in the present disclosure. In order to more clearly understand the technical means in the present disclosure, the technical means can be carried out according to the contents of the description. In order to make the objectives above, other objectives, characteristics and advantages of the present disclosure more easy to understand, embodiments of the present disclosure are illustrated as follows.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flow chart of a code processing method according to a first embodiment of the present disclosure.

FIG. 2 is a step flow chart of a code processing method according to a second embodiment of the present disclosure.

FIG. 3 is a step flow chart of a code processing method according to a third embodiment of the present disclosure.

FIG. 4 is a structure diagram of a hardware configuration tree according to the present disclosure.

FIG. 5 is a code processing and saving structure diagram according to the present disclosure.

FIG. 6 is a step flow chart of a code processing method according to a fourth embodiment of the present disclosure.

FIG. 7 is a structure diagram of a code processing device according to a first embodiment of the present disclosure.

FIG. 8 is a structure diagram of a code processing device according to a second embodiment of the present disclosure.

FIG. 9 is a structure diagram of a code processing device according to a third embodiment of the present disclosure.

FIG. 10 is a structure diagram of a code processing device according to a fourth embodiment of the present disclosure.

FIG. 11 is a schematic diagram of the mobile terminals for carrying out the method according to the present disclosure.

FIG. 12 is a schematic diagram for maintaining or carrying a program code memory cell according to the method of the present disclosure.

### DETAILED DESCRIPTION

In order to clarify the objectives, technical schemes and advantages of the embodiments of the present disclosure, the technical schemes in the embodiments of the present disclosure are described clearly and integrally by combining the drawings in the embodiments of the present disclosure. Obviously, the embodiments described are some embodiments of the present disclosure, rather than all embodiments. Based on the embodiments of the present disclosure, all of the other embodiments obtained by those skilled in the art without creative work are within the protection scope of the present disclosure.

### Method Embodiment 1

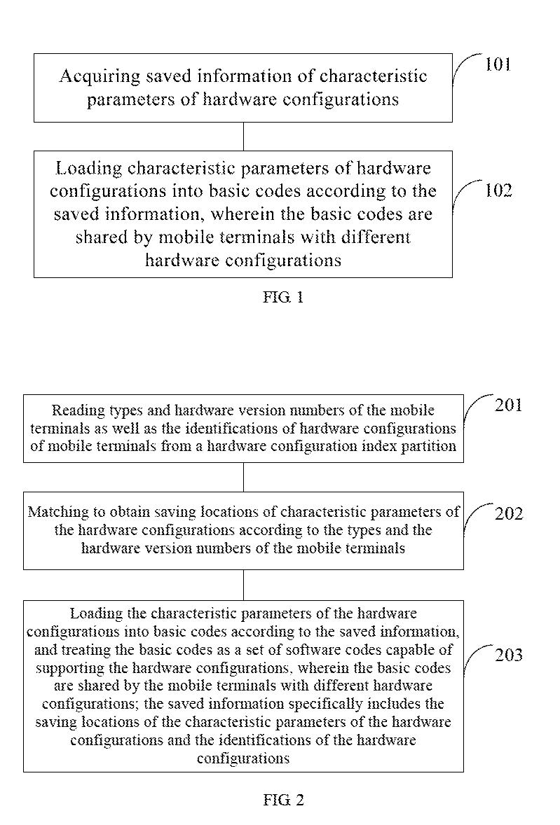

A step flow chart of a code processing method according to a first embodiment of the present disclosure is shown in FIG. 1. The code processing method specifically includes:
step 101: acquiring saved information of characteristic parameters of hardware configurations;
step 102: loading the characteristic parameters of the hardware configurations into basic codes according to saved information, wherein the basic codes are shared by the mobile terminals with different hardware configurations.

The code processing method can be applicable to mobile phones, tablet computers and other mobile terminals, and configured to load the characteristic parameters of the hardware configurations of the mobile terminals into the basic codes, so that the basic codes become a set of software codes capable of supporting the hardware configurations, so as to reduce the development and maintenance workload of the software codes in the mobile terminals.

According to the embodiment of the present disclosure, the hardware configurations are specifically applicable to representing the basic configurations of the hardware inside the mobile terminals, such as LCDs (Liquid Crystal Display), memories, hard disks, etc. The embodiment of the present disclosure is described by taking that the hardware configurations represent LCDs as the example, the characteristic parameters of the hardware configurations representing LCDs specifically include: resolution ratio, responsible time, signal input interfaces, contrast ratio, brightness, visual angles, etc.

According to the embodiment of the present disclosure, the basic codes are applicable to representing the codes shared by the mobile terminals with different hardware configurations, including parametric variables of the hardware configurations corresponding to the characteristic parameters of the hardware configurations. According to an optional embodiment of the present disclosure, the step of loading the characteristic parameters of the hardware configurations into basic codes according to the saved information specifically includes:
assigning the characteristic parameters of the hardware configurations to the parametric variables of the hardware configurations corresponding to the characteristic parameters of the hardware configurations in the basic codes; thus the characteristic parameters of the hardware configurations can be loaded into the basic codes, so that the basic codes become a set of software codes capable of supporting the hardware configurations.

In order that those skilled in the art can better understand the technical scheme of the present disclosure, the embodiment of the present disclosure is illustrated with specific examples as follows.

For example, according to the embodiment of the present disclosure, the basic codes specifically include the parametric variables of the hardware configurations corresponding to the characteristic parameters of the hardware configurations representing LCDs: resolution variable, response time variable, signal input interface variable, contrast variable, brightness variable, visual angle variable, etc.; if the hardware configurations represent certain model of LCD, the characteristic parameters of the hardware configurations representing LCD specifically include: the resolution ratio is 2560×1440, the response time is 4 ms, the signal input interface is an audio input interface, the contrast ratio is 50 million:1, the brightness is 300 cd/m³, the visual angle is 178/178 degrees, etc., in the embodiment of the present disclosure: the resolution ratio 2560×1440 is assigned to the resolution variable, the response time 4 ms is assigned to the response time variable, the signal input interface, namely the audio input interface is assigned to the signal input interface variable, the contrast ratio 50 million:1 is assigned to the contrast variable, the brightness 300 cd/m³ is assigned to the brightness variable, the visual angle 178/178 degrees is assigned to the visual angle variable, etc.; thus, the basic codes can be treated as a set of software codes with characteristic parameter values of the hardware configurations and a function of supporting the hardware configurations.

In conclusion, according to the code processing method disclosed in the embodiment of the present disclosure, the relevant characteristic parameters of the hardware configurations are loaded into the basic codes, so that the basic codes become a set of integral software codes capable of supporting the hardware configurations of the mobile terminals. Because the mobile terminals with different hardware configurations share the basic codes, namely a plurality of hardware configurations can share the basic codes; therefore, compared with a set of software codes corresponding to various mobile terminals with different hardware configurations in prior art, the relevant characteristic parameters of the hardware configurations and the basic codes shared by various hardware devices can be treated as a set of software codes, namely a set of software codes are developed and saved in the mobile terminals; therefore, the development and maintenance workload of the software codes in the mobile terminals is reduced.

On the other hand, only a set of software codes is saved in the mobile terminals, so that the step of controlling the mobile terminals to determine which set of software codes to use via a complex compiling switch is saved, and the workload is reduced; according to the present disclosure, the basic codes are treated in a way of loading the characteristic parameters of the hardware configurations into the basic codes, so that when the hardware configurations are changed, the characteristic parameters corresponding to the hardware configurations in the basic codes are updated only; therefore, when the software codes are developed, it is not necessary to depend on the hardware configurations and consider the changes of the hardware configurations.

### Method Embodiment 2

A step flow chart of a code processing method according to a second embodiment of the present disclosure is shown in FIG. 2. The code processing method specifically includes:
step 201: reading types and hardware version numbers of the mobile terminals as well as the identifications of hardware configurations of mobile terminals from a hardware configuration index partition;
step 202: matching to obtain saving locations of characteristic parameters of the hardware configurations according to the types and the hardware version numbers of the mobile terminals;
step 203: loading the characteristic. parameters of the hardware configurations into basic codes according to saved information, and treating the basic codes as a set of software codes capable of supporting the hardware configurations, wherein the basic codes are shared by the mobile terminals with different hardware configurations; the saved information specifically includes the saving locations of the characteristic parameters of the hardware configurations and the identifications of the hardware configurations.

Compared with the method embodiment 1, according to the embodiment of the present disclosure, the saved information is refined into the saving locations of the characteristic parameters of the hardware configurations and the identifications of the hardware configurations; and the step of searching the saved information of the characteristic parameters of the hardware configurations according to step 201 and step 202 is refined, thereby acquiring the saved information of the characteristic parameters of the hardware configurations in a way of reading the types and the hardware version numbers of the mobile terminals as well as the identifications of the hardware configurations.

According to the embodiment of the present disclosure, those skilled in the art can first divide the software codes into two partitions, a partition is specifically applicable to save the basic codes, and the other partition is adopted as a hardware configuration index partition and specifically applicable to save the types, the hardware software numbers of the mobile terminals, as well as the identifications of the hardware configurations.

According to an optional embodiment of the present disclosure, the step of matching to acquire the saving locations of the characteristic parameters of the hardware configurations according to the types and the hardware version numbers of the mobile terminals specifically includes:
step S1: parsing the types and the hardware version numbers of the mobile terminals to obtain corresponding hardware configuration parsing information;
step S2: searching code saving folders with names corresponding to the hardware configuration parsing information;
step S3: determining that the code saving folders are the saving locations of the characteristic parameters of the hardware configurations.

According to the embodiment of the present disclosure, the code saving folders are applicable to save the characteristic parameters of the hardware configurations, a plurality of code saving folders can be contained in the mobile terminals to separately save the characteristic parameters of the different types of the hardware configurations, such that two code saving folders are separately applicable to save the characteristic parameters of LCDs and the memories.

According to an optional embodiment of the present disclosure, the corresponding hardware configuration parsing information which is obtained by parsing the types and the hardware version numbers of the mobile terminals is in the farm of a string, and the step of searching code saving folders with names corresponding to the hardware configuration parsing information specifically includes:
searching the code saving folders with names that are the same as the character strings; or
searching the names of the code saving folders corresponding to the character strings in a database.

According to the embodiment of the present disclosure, correspondences between the code saving folders and the hardware configuration parsing information can be saved in the database, namely after obtaining the hardware configuration parsing information in a way of parsing, the names of the code saving folders corresponding to the character strings representing the hardware configuration parsing information can be searched from the database, so as to search the code saving folders with names corresponding to the hardware configuration parsing information. Or the code saving folders can be named after the hardware configuration parsing information, namely after obtaining the hardware configuration parsing information in a way of parsing, the code saving folders with names that are the same as the character strings representing the hardware configuration parsing information from the database can be searched, so as to search the code saving folders with names corresponding to the hardware configuration parsing information.

### Method Embodiment 3

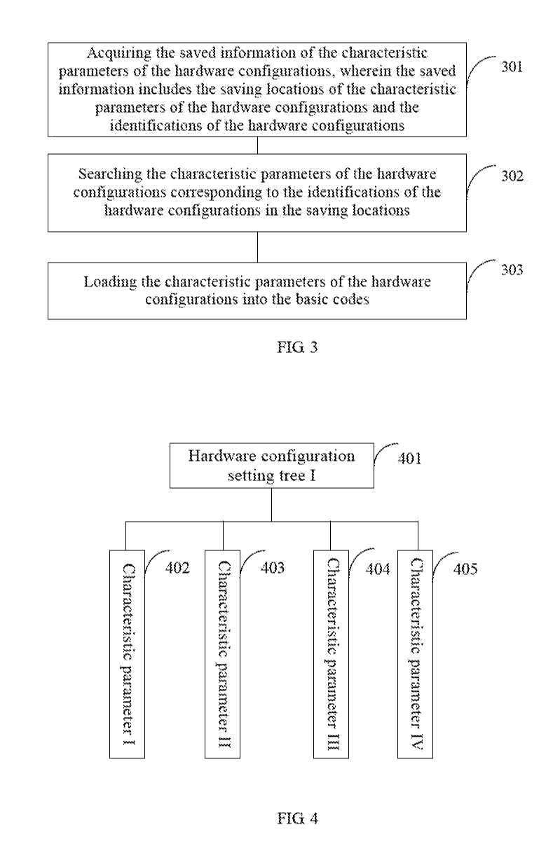

A step flow chart of a code processing method according to a third embodiment of the present disclosure is shown in FIG. 3. The code processing method. specifically includes:
step 301: acquiring the saved information of the characteristic parameters of the hardware configurations, wherein the saved information includes the saving locations of the characteristic parameters of the hardware configurations and the identifications of the hardware configurations;
step 302: searching the characteristic parameters of the hardware configurations corresponding to the identifications of the hardware configurations in the saving locations;
step 303: loading the characteristic parameters of the hardware configurations into the basic codes.

Compared with the embodiment 1, according to the embodiment of the present disclosure, the saved information specifically includes the saving locations of the characteristic parameters of the hardware configurations and the identifications of the hardware configurations; and the step of loading the characteristic parameters of the hardware configurations into the basic codes is refined following step 302 and step 303 according to the saved information, thereby searching the characteristic parameters of the hardware configurations in the saving locations according to the identifications of the hardware configurations, and then loading the characteristic parameters of the hardware configurations into the basic codes, so that the basic codes become a set of software codes capable of supporting the hardware configurations.

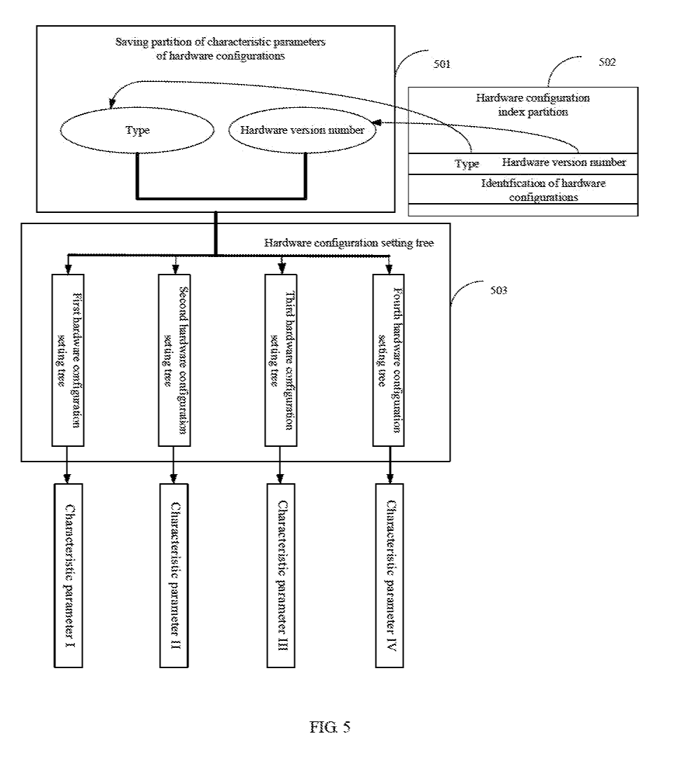

According to an optional embodiment of the present disclosure, the characteristic parameters of the hardware configurations can be saved in a hardware configuration setting tree. A structure diagram of a hardware configuration tree according to the present disclosure is shown in FIG. 4. The structure specifically includes: a root node: a hardware configuration setting tree I 401; child nodes: a characteristic parameter I 402, a characteristic parameter II 403, a characteristic parameter III 404 and a characteristic parameter IV 405.

It is understood that the root node of the hardware configuration setting tree is the hardware configuration setting tree I, the child nodes are the characteristic parameter I, the characteristic parameter II, the characteristic parameter III and the characteristic. parameter IV, which are adopted as an example of the structure of the hardware configuration setting tree in the embodiment of the present disclosure, rather than a limitation to the hardware configuration setting tree; actually, the root node of the hardware configuration setting tree is an identification of the hardware configurations, the number of the child nodes is determined according to the number of the characteristic parameters of the hardware configurations, for example, if the hardware configurations represent LCD of a brand, the root node is the identification of LCD of this brand; the child nodes include resolution variable, response time variable, signal input interface variable, contrast variable, brightness variable, visual angle variable, etc.; according to the embodiment of the present disclosure, the structure of the hardware configuration setting tree is not limited specifically.

The step of searching the characteristic parameters of the hardware configurations corresponding to the identifications of the hardware configurations in the saving locations specifically includes:
step A1: searching the hardware configuration setting tree corresponding to the identifications of the hardware configurations in the saving locations;
step A2: reading the characteristic parameters of the hardware configurations from the hardware configuration setting tree.

According to the embodiment of the present disclosure, the parameters of the hardware configurations are saved in the hardware configuration setting tree, and the hardware configuration setting tree capable of saving the characteristic parameters of a plurality of hardware configurations can be saved in the saving locations, for example, the hardware configuration tree capable of saving the characteristic parameters of different types and different brands of LCDs can be saved in the saving location I (LCD code saving folder), wherein the hardware configuration setting tree has a unique identification, so as to represent the hardware configurations corresponding to the characteristic parameters saved in the hardware configuration setting tree.

According to the embodiment of the present disclosure, as a way of reading the identifications of the hardware configurations, the hardware configuration setting tree corresponding to the identifications of the hardware configurations can be searched in the saving locations according to the identifications of the hardware configurations, thereby reading the characteristic parameters of the hardware configurations saved in the hardware configuration setting tree.

According to the embodiment of the present disclosure, when the mobile terminals start, the characteristic parameters of the hardware configurations can be loaded into the basic codes via a code processing device, thus the basic codes become a set of software codes with characteristic parameter values of the hardware configurations and a function of supporting the hardware configurations.

A code processing and saving structure diagram according to the present disclosure is shown in FIG. 5. The code processing and saving structure specifically includes: a saving partition 501 of characteristic parameters of hardware configurations, a hardware configuration index partition 502 and a hardware configuration setting tree 503. The saving partition 501 of the characteristic parameters of the hardware configurations is applicable to save the hardware configuration setting tree 503; the hardware configuration index partition 502 is applicable to save types and hardware versions of mobile terminals, identifications of the hardware configurations and other information; the hardware configuration setting tree 503 is applicable to save the characteristic parameters of the hardware configurations.

According to the embodiment of the present disclosure, the code processing device can acquire the types and the hardware version numbers of the mobile terminals as well as the identifications of the hardware configurations from the hardware configuration index partition 502; the code processing device can acquire the saving partition 501 of the characteristic parameters of the hardware configurations according to the types and the hardware version numbers of the hardware configurations; the code processing device can search the hardware configuration setting tree 503 corresponding to the identifications of the hardware configurations from the saving location 501 of the characteristic parameters of the hardware configurations; the code processing device can read the characteristic parameters 504 of the hardware configurations from the hardware configuration setting tree 503 and load the characteristic parameters 504 into the basic codes;

for example, the saving locations of the characteristic, parameters of the hardware configurations obtained according to the types and the hardware version numbers of the hardware configurations are the LCD folder, three hardware configuration setting trees are saved in the LCD folder, including: the first hardware configuration setting tree, the second hardware configuration setting tree and the third hardware configuration setting tree to which the characteristic parameters of LCDs of three different manufacturers separately are saved; if LCD of manufacturer 1 is adapted to the mobile terminals, the identifications of the hardware configurations are the first hardware configuration setting tree, thus the hardware configuration setting tree searched according to the identifications of the first hardware configuration tree is the first hardware configuration setting tree, the characteristic parameters in the first hardware configuration setting tree are read into the basic codes, so that the basic codes become a set of software codes capable of supporting LCD of the manufacturer 1.

If LCD of manufacturer 2 is adapted to the mobile terminals, the identifications of the hardware configurations are the second hardware configuration setting tree, the hardware configuration setting tree searched according to the identifications of the second hardware configuration tree is the second hardware configuration setting tree, the characteristic parameters in the second hardware configuration setting tree are read into the basic codes, so that the basic codes become a set of software codes capable of supporting LCD of the manufacturer 2.

### Method Embodiment 4

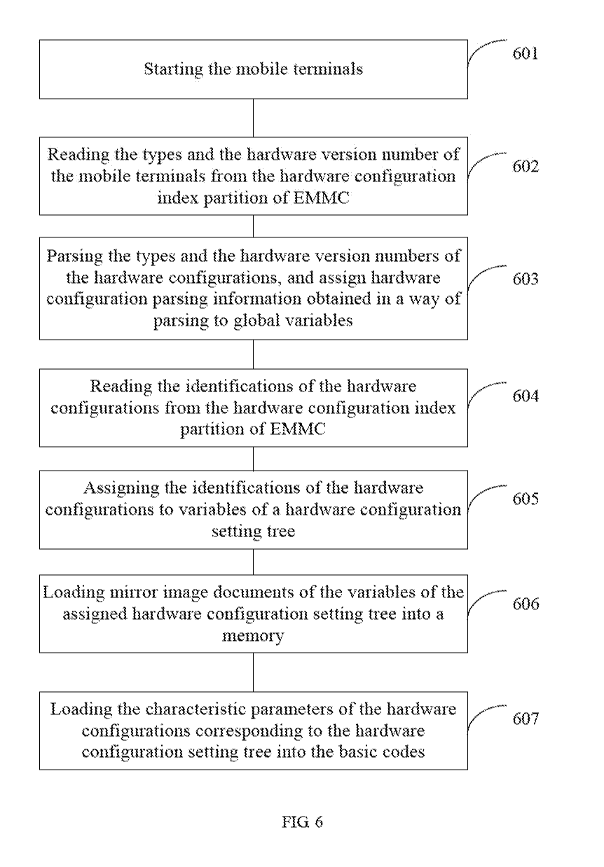

A step flow chart of a code processing method according to a fourth embodiment of the present disclosure is shown in FIG. 6. The code processing method specifically includes steps as follows.

Step 601: Starting mobile terminals.

The code processing method is applicable to the mobile terminals. When the mobile terminals start, characteristic parameters of hardware configurations of the mobile terminals are loaded into basic codes, so that the basic codes can be treated as a set of software codes capable of supporting the hardware configurations of the mobile terminals.

Step 602: Reading types and hardware version numbers of the hardware configurations from a hardware configuration index partition of EMMC (Embedded Multi Media Card).

Step 603: Parsing the types and the hardware version numbers of the hardware configurations, and assign hardware configuration parsing information obtained in a way of parsing to global variables.

Step 604: Reading the identifications of the hardware configurations from the hardware configuration index partition of EMMC.

Step 605: Assigning the identifications of the hardware configurations to variables of a hardware configuration setting tree.

Step 606: Loading mirror image documents of the variables of the assigned hardware configuration setting tree into a memory.

According to the embodiment of the present disclosure, the variables of the assigned hardware configuration setting tree are the hardware configuration setting tree corresponding to the hardware configurations, and the mirror image documents of the variables of the assigned hardware configuration setting tree are loaded into the memory, namely the minor image documents of the hardware configuration setting tree are loaded into the memory.

Step 607: Loading the characteristic parameters of the hardware configurations corresponding to the hardware configuration setting tree into the basic codes.

According to the embodiment of the present disclosure, the code saving folders of different saved characteristic parameters can be accessed in a way of assigning the global variables, so as to obtain the characteristic parameters corresponding to the hardware configurations. The characteristic parameters of the hardware configurations are loaded into the basic codes in a way of loading the mirror image documents, thereby loading the characteristic parameters of the hardware configurations into the basic code, so that the basic codes become a set of software codes capable of supporting the hardware configurations.

### Device Embodiment 1

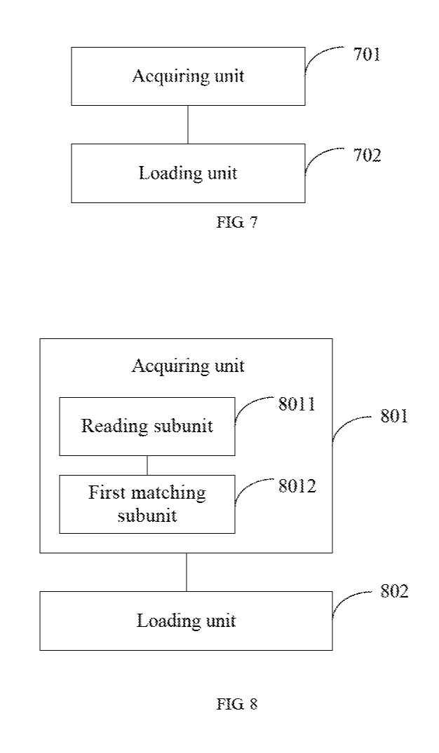

A structure diagram of a code processing device according to a first embodiment of the present disclosure is shown in FIG. 7. The code processing device specifically includes an acquiring unit 701 and a loading unit 702,
wherein the acquiring unit 701, configured to acquire saved information of characteristic parameters of hardware configurations;
a loading unit 702, configured to load the characteristic parameters of the hardware configurations into basic codes according to the saved information, wherein the basic codes are shared by mobile terminals with different hardware configurations.

### Device Embodiment 2

A structure diagram of a code processing device according to a second embodiment of the present disclosure is shown in FIG. 8. The code processing device specifically includes an acquiring unit 801 and a loading unit 802,
wherein the acquiring unit 801, configured to acquire saved information of characteristic parameters of hardware configurations;
a loading unit 802, configured to load the characteristic parameters of the hardware configurations into basic codes according to the saved information, wherein the basic codes are shared by mobile terminals with different hardware configurations.

According to the embodiment of the present disclosure, the saved information specifically includes saving locations of the characteristic parameters of the hardware configurations and identifications of the hardware configurations.

The acquiring unit 801 specifically includes:
a reading subunit 8011, configured to read types and hardware version numbers of the mobile terminals as well as the identifications of the hardware configurations from a hardware configuration index partition;
first matching subunit 8012, configured to match to obtain the saving locations of the characteristic parameters of the hardware configurations according to the types and the hardware version numbers of the mobile terminals.

According to an optional embodiment of the present disclosure, the first matching subunit 8012 specifically includes:
a parsing module, configured to parse types and hardware version numbers of the mobile terminals to obtain corresponding hardware configuration parsing information;
a first searching module, configured to search code saving folders with names corresponding to the hardware configuration parsing information;
a determining module, configured to determine that the code saving folders are the saving locations of the characteristic parameters of the hardware configurations;

wherein the hardware configuration parsing information can be character strings, and the first searching module specifically includes:
a first folder searching submodule, configured to search the code saving folders with names that are the same as the character strings; or
a second folder searching submodule, configured to search the names of the code saving folders corresponding to the character strings in a database.

### Device Embodiment 3

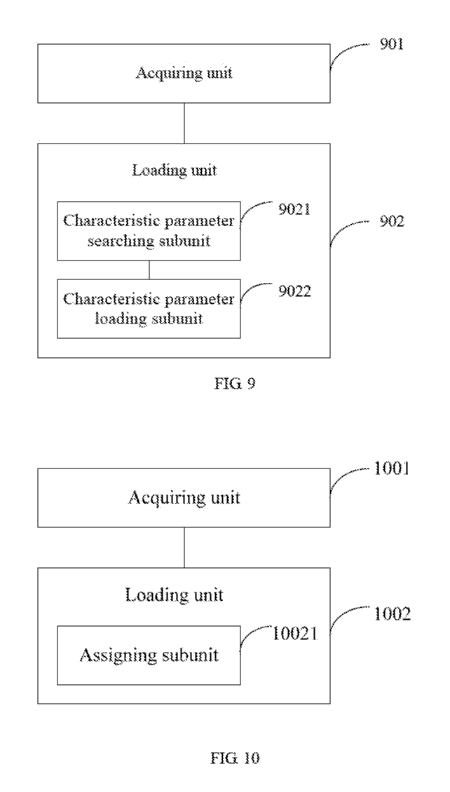

A structure diagram of a code processing device according to a third embodiment of the present disclosure is shown in FIG. 9. The code processing device specifically includes an acquiring unit 901 and a loading unit 902,
wherein the acquiring unit 901, configured to acquire saved information of characteristic parameters of hardware configurations;
a loading unit 902, configured to load the characteristic parameters of the hardware configurations into basic codes according to the saved information, wherein the basic codes are shared by the mobile terminals with different hardware configurations.

According to the embodiment of the present disclosure, the saved information specifically includes saving locations of the characteristic parameters of the hardware configurations and identifications of the hardware configurations.

The loading unit 902 specifically includes:
a characteristic parameter searching subunit 9021, configured to search the characteristic parameters of the hardware configurations corresponding to the identifications of the hardware configurations in the saving locations;
a characteristic parameter loading subunit 9022, configured to load the characteristic parameters of the hardware configurations into the basic codes.

According to an optional embodiment of the present disclosure, the characteristic parameter searching subunit 9021 specifically includes:
a second searching module, configured to search the hardware configuration setting tree corresponding to the identifications of the hardware configurations in the saving locations;
a characteristic parameter reading module, configured to read the characteristic parameters of the hardware configurations from the hardware configuration setting tree.

### Device Embodiment 4

A structure diagram of a code processing device according to a fourth embodiment of the present disclosure is shown in FIG. 10. The code processing device specifically includes an acquiring unit 1001 and a loading unit 1002,
wherein the acquiring unit 1001, configured to acquire saved information of characteristic parameters of hardware configurations;
a loading unit 1002, configured to load the characteristic parameters of the hardware configurations into basic. codes according to the saved information, wherein the basic codes are shared by the mobile terminals with different hardware configurations.

The loading unit 1002 specifically includes:
an assigning subunit 10021, configured to assign the characteristic parameters of the hardware configurations to parametric variables of the hardware configurations corresponding to the characteristic, parameters of the hardware configurations in the basic codes, thus the basic codes become a set of software codes capable of supporting the hardware configurations.

The device embodiments described above are schematic only, wherein units described as separate components can be or cannot be separated physically; components which are adopted as display units can be or cannot be physical units, namely located on a place or distributed to a plurality of network units. The purpose of the schemes in the embodiment can be achieved via partial or all modules according to actual requirements. Those skilled in the art can understand and implement without creative labor.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

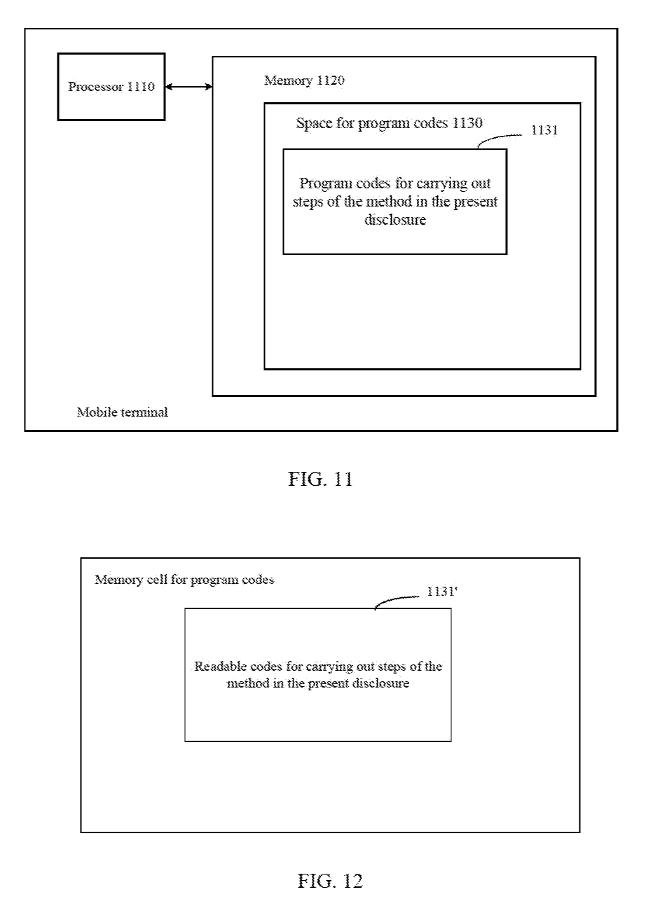

For example, FIG. 11 illustrates a block diagram of a mobile terminal for executing the method according the disclosure. Traditionally, the mobile terminal includes a processor 1110 and a computer program product or a computer readable medium in form of a memory 1120. The memory 1120 could be electronic memories such as flash memory, EEPROM (Electrically Erasable Programmable Read-Only Memory), EPROM, hard disk or ROM. The memory 1120 has a memory space 1130 for executing program codes 1131 of any steps in the above methods. For example, the memory space 1130 for program codes may include respective program codes 1131 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 12. The memory cells may be provided with memory sections, memory spaces, etc., similar to the memory 1120 of the server as shown in FIG. 11. The program codes may be compressed for example in an appropriate form. Usually, the memory cell includes computer readable codes 1131′ which can be read for example by processors 1110. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

Finally, it should be noted that the embodiments above are applicable to describe the technical schemes of the present disclosure only, rather than limiting the technical schemes. Though the present disclosure is described in detail with the embodiments, those skilled in the art shall understand that they can modify the technical schemes recorded in the embodiments, or equivalently replace partial technical characteristics, but the essence of the corresponding technical schemes do not depart from the spirit and scopes of the technical schemes in the embodiments of the present disclosure because of those modifications and replacements.

What is claimed is:

1. A code processing method, Wherein the method comprises:
acquiring saved information of characteristic parameter of hardware configuration;
loading the characteristic parameter of the hardware configuration into basic code according to the saved information, wherein the basic code is shared by mobile terminals with different hardware configurations.

2. The method according to claim 1, wherein the saved information comprises saving location of the characteristic parameter of the hardware configuration and identification Of the hardware configuration; the step of acquiring the saved information of the characteristic parameter of the hardware configurations comprises:
reading type and hardware version number of the mobile terminal as well as the identification of hardware configuration of the mobile terminal from a hardware configuration index partition;
matching to acquire the saving location of the characteristic: parameter of the hardware. configuration according to the type and the hardware version number of the mobile terminal.

3. The method according to claim 2, wherein the step of matching to acquire the saving location of the characteristic parameter of the hardware configuration according to the type and the hardware version number of the mobile terminals comprises:
parsing the type and the hardware version number of the mobile terminal to acquire corresponding hardware configuration parsing information;
searching code saving folder with name corresponding to the hardware configuration. parsing information;
determining that the code saving folder are the saving location of the characteristic parameter of the hardware configuration.

4. The method according to claim 3, wherein the hardware configuration parsing information is in the form of a string, the step of searching the names of the code saving folders corresponding to the hardware configuration parsing information comprises:
searching the code saving folder with name the satire as the character string; or
searching the name of the code saving folder corresponding to the character string in a database.

5. The method according to claim 1, wherein the saved information comprises the saving location of the characteristic parameter of the hardware configuration and the identification of the hardware configuration; the step of loading the characteristic parameter of the hardware configuration into the basic code according to the saved information comprises:
searching the characteristic parameter of the hardware configuration corresponding to the identification of the hardware configuration in the saving locations;
loading the characteristic parameter of the hardware configuration into the basic code.

6. The method according to claim 5, wherein the step of searching the characteristic parameter of the hardware configuration corresponding to the identification of the hardware configuration in the saving location comprises:
searching a hardware configuration setting tree corresponding to the identification of the hardware configuration in the saving location;
reading the characteristic parameter of the hardware configuration from the hardware configuration setting tree.

7. The method according to claim 1, wherein the step of loading the characteristic parameter of the hardware configuration into the basic code according to the saved information comprises:
assigning the characteristic parameter of the hardware configurations to parametric variable of the hardware configuration corresponding to the characteristic parameter of the hardware configuration in the basic code, so that the characteristic parameters of the hardware configuration is loaded into the basic code, thus the basic code becomes a set of software code capable of supporting the hardware configuration.

8. A mobile terminal for code processing, wherein the mobile terminal comprises:
at least one processor; and
a memory communicably connected with the at least one processor for storing instructions executable by the at least one processor, wherein execution of the instructions by the at least one processor causes the at least one processor to:
acquire saved information of characteristic parameter of hardware configuration; and
load the characteristic parameter of the hardware configuration into basic code according to the saved information, wherein the basic code are shared by the mobile terminal with different hardware configurations.

9. The mobile terminal according to claim 8, wherein the saved information comprises saving location of the characteristic parameter of the hardware configuration and identification of the hardware configuration; acquire saved information of characteristic parameter of hardware configuration comprises:
read types and hardware version numbers of the mobile terminal as well as the identification of the hardware configuration from a hardwire configuration index partition; and
match to acquire the saving location of the characteristic parameter of the hardware configuration according to the type and the hardware version number of the mobile terminal.

10. The mobile terminal according to claim 9, wherein match to acquire the saving location of the characteristic parameter of the hardware configuration according to the type and the hardware version number of the mobile terminal comprises:
parse the type and the hardware version number of the mobile terminal to acquire corresponding hardware configuration parsing information;
search code saving folder with names corresponding to the hardware configuration parsing information;
determine that the code saving folder is the saving location of the characteristic parameter of the hardware configuration.

11. The mobile terminal according to claim 10, wherein the hardware configuration parsing information is in the form of a string, and search code saving folder with names corresponding to the hardware configuration parsing information comprises:
search the code saving folder with name the same as the character string; or
search the name of the code saving folder corresponding to the character string in a database.

12. The mobile terminal according to claim 8, wherein the saved information comprises the saving location of the characteristic parameter of the hardware configuration and the identification of the hardware configuration; load the characteristic parameter of the hardware configuration into basic code according to the saved information comprises:
search the characteristic parameters of the hardware configuration corresponding to the identification of the hardware configuration in the saving location; and
load the characteristic parameter of the hardware configuration into the basic code,

13. The mobile terminal according to claim 12, wherein search the characteristic parameters of the hardware configuration corresponding to the identification of the hardware configuration in the saving location comprises:
search a hardware configuration setting tree corresponding to the identification of the hardware configuration in the saving location;
read the characteristic parameter of the hardware configuration from the hardware configuration setting tree.

14. The mobile terminal according to claim 8, wherein load the characteristic parameter of the hardware configuration into basic code according to the saved information comprises:
assign the characteristic parameter of the hardware configuration to parametric variable of the hardware configuration corresponding to the characteristic parameter of the hardware configuration in the basic code, thus the characteristic parameter of the hardware configuration is loaded into the basic code, so that the basic code becomes a set of software code capable of supporting the hardware configuration.

15. A non-transitory computer readable medium storing executable instructions that, when executed by a mobile terminal, cause the electronic device to:
acquire saved information of characteristic parameter of hardware configuration; and
load the characteristic parameter of the hardware configuration into basic code according to the saved information, wherein the basic code are shared by the mobile terminal with different hardware configurations.
